(19) United States
(12) Patent Application Publication
(10) Pub. No.: US 2025/0164450 A1
(43) Pub. Date: May 22, 2025

(54) MEASURING DEVICE AND METHOD FOR ANALYZING A SAMPLE

(71) Applicant: Anton Paar QuantaTec Inc., Boynton Beach, FL (US)

(72) Inventor: Pei-ming Wu, Boynton Beach, FL (US)

(21) Appl. No.: 18/511,798

(22) Filed: Nov. 16, 2023

(51) Int. Cl. G01N 29/34; G01N 29/024; G01N 29/14

(52) U.S. Cl. CPC G01N 29/348; G01N 29/024; G01N 29/14; G01N 2291/045; G01N 2291/048

(57) ABSTRACT

A measuring device for analyzing a sample, which comprises:
i) a container configured to accommodate the sample in a container volume, wherein the container comprises a uniform cross-section,
ii) a sonic emitter unit configured to emit sonic waves into the container towards the sample,
iii) a sonic receiver unit configured to receive reflected sonic waves and standing sonic waves which are formed by combinations of the emitted sonic waves and the reflected sonic waves,
iv) a control unit configured to determine at least one resonance frequency based on the received standing sonic waves and to determine at least one sample parameter based on the at least one determined resonance frequency.

### FIELD OF THE DISCLOSURE

The disclosure relates to a measuring device for analyzing a sample, in particular regarding a volume and/or a density, wherein the measuring device comprises a container configured to accommodate the sample, a sonic emitter unit, a sonic receiver unit, and a control unit. Further, the disclosure relates to a method of analyzing a sample. Thus, the disclosure may relate to the technical field of measuring devices, in particular with respect to a sample parameter such as density.

### Technological Background

In order to determine characteristics of the sample such as a sample volume or a sample density, various measuring devices can be used. These measuring devices have become more efficient due to the increasing extent to which laboratory measuring processes have become automated. However, most conventional measuring devices for measuring sample properties such as density or volume still require manual handling and/or calibration. For example, in most conventional density measurements of a sample (e.g a powder sample), an operator needs to visually inspect a graduated cylinder in order to obtain the height of the powder sample before and after each tapping cycle. From the height of the powder sample, the volume and subsequently the density can then be determined.

However, while there exist methods that provide automated determination of volume and density, they require calibration to reduce the measuring error caused by the distance between the sensor and the cylinder and/or sample. Furthermore, these measurement methods are sensitive to the sensor's location in relation to the sample. Moreover, the results of the laser-based volume measurement may be affected by the optical properties of the sample. Another issue affecting measuring results is a rough (i.e. non-flat) surface.

### SUMMARY OF THE DISCLOSURE

There may be a need to analyze a sample in an accurate, robust and reliable, in particular automatic, manner. A measuring device and a method of analyzing a sample are provided.

According to an aspect of the disclosure, there is described a (automated) measuring device for analyzing a sample (e.g. a solid sample, in particular a powder), which comprises:
i) a container (e.g. a cylinder) configured to accommodate the sample in a container volume, in particular wherein the container comprises a uniform cross-section,
ii) a sonic emitter unit (e.g. a loudspeaker) configured to emit sonic waves (acoustic signals, in particular a frequency sweep) into the container (through a fluid column that is free of the sample) towards the sample, iii) a sonic receiver unit (e.g. a microphone) configured to receive reflected sonic waves (in particular reflections of the emitted sonic waves, more in particular reflected at the sample) and standing sonic waves which are formed by combinations of the emitted sonic waves and the reflected sonic waves (within the container),
iv) a control unit (e.g. one or more processors; for example comprising one or more control elements) configured to determine at least one resonance frequency based on the received standing sonic waves and to determine at least one sample parameter (e.g. a sample volume or a sample density) based on the at least one determined resonance frequency.

According to another aspect of the disclosure, there is described a method of analyzing a sample, wherein the method comprises:
i) providing a sample in a container,
ii) sending sonic waves into the container towards the sample,
iii) receiving standing sonic waves which are formed by combinations of the emitted sonic waves and reflected sonic waves,
iv) determining at least one resonance frequency based on the received standing sonic waves, and
v) determining a sample parameter based on the at least one determined resonance frequency.

According to another aspect of the disclosure, there is described a use (method of using) of sonic waves in a fluid column (e.g. an air column) located in a container in contact with a sample to determine a sample parameter.

In the context of the present document, the term “sonic emitter unit” may particularly denote any kind of device configured to generate and/or send/emit a sonic wave or a plurality of sonic waves, in particular towards a sample. In an example, the sonic emitter unit is configured to convert electrical energy into acoustic energy (as a sound wave) and may comprise different types of transducers or transmitters depending on e.g. the desired frequency range. Preferably, the sonic emitter unit may be configured to sweep over a specific frequency range. In a specific embodiment, the sonic emitter unit is implemented as a loudspeaker.

In the context of the present document, the term “sonic receiver unit” may particularly denote any kind of device configured to receive a sonic wave or a plurality of sonic waves, in particular reflected sonic waves and/or standing sonic waves (which are formed by combinations of the emitted and reflected sonic waves). In particular, the sonic receiver unit may be configured to convert the mechanical vibration of the sonic standing waves (acoustic signals) into an electrical signal or a plurality of electrical signals that may be processed and analyzed by a control unit. Preferably, the sonic receiver unit may be configured to receive a plurality of signals from a sweep over a specific frequency range. In a specific embodiment, the sonic receiver unit is implemented as a microphone.

In the context of the present document, the term “control unit” (or control device) may particularly denote any kind of device configured to determine at least one resonance frequency based on received standing sonic waves and/or to determine at least one sample parameter based on the at least one determined resonance frequency (said task may be for example performed by a first control element and/or a second control element). In an embodiment, the control unit may be configured as a processor, in particular a microprocessor or microcontroller.

The control unit may be a single device or comprise two or more parts (hereafter referred to as control elements). The control unit may be entirely embedded within the housing of the measuring device or may be located remotely as a stand-alone device or may be distributed at both, the measuring device and the remote stand-alone device (e.g. as two control elements). The control unit may be configured to carry out some or all steps of the method for the determination of the sample parameter. The control unit or at least one control element may be integrated in a common structure (cover structure) with the sonic emitter unit and the sonic receiver unit. The control unit or at least one control element may be coupled to the sonic emitter/receiver unit in a wired or wireless manner. The control unit (or a control element) may also operate remotely (e.g. via a network). In case that the control unit comprises two or more control elements, the at least two control elements may be directly coupled (wired, wireless) or may communicate in a remote manner, e.g. via a network.

In an embodiment, the control unit or a part thereof may be configured as an embedded system, in particular an embedded computer comprised of microprocessors and peripherals.

In the context of the present document, the term “sample parameter” may particularly denote any kind of parameter which may be determined based on the at least one determined resonance frequency. In this regard, the sample parameters are characteristics that can be used to describe or analyze the sample. In particular, the sample parameter may be, but is not restricted to, e.g. one of a sample volume or a sample density.

In the context of the present document, the term “sample” may particularly denote any kind of medium placed inside of a (sample) container and of which parameter(s) are to be determined. The sample may be solid such as powder or the sample may be a liquid. When the sample is placed in the container, there may be a fluid column present above the sample. Said fluid column may comprise a gas (such as air) or a liquid.

According to an exemplary embodiment, the disclosure may be based on the idea that a sample parameter (such as a sample volume or a sample density) in a container may be (automatically) determined by a simple and compact device in an accurate, reliable and secure manner, when sonic waves are sent (in particular as a frequency sweep), in particular by a sonic emitter unit, through a fluid column towards/down to a (solid or liquid) sample in a sample container (e.g. a cylinder), and the resulting standing sonic waves, which are formed from a combination of the emitted sonic waves and reflected sonic waves, are investigated with respect to one or more resonance frequencies. The sample parameter(s) (for example the height of the fluid column above the sample) are determined based on the at least one determined resonance frequency. For this purpose, the first and/or higher harmonic resonance frequencies may be used. In a preferred example, the sonic emitter unit and/or a sonic receiver unit may be arranged directly at or in a cover structure that closes the sample container like a plug.

The measuring device may allow to conduct non-destructive measurements, such that the sample parameters are determined without damaging or contaminating the sample and therefore allowing repeated measurements. In particular, the described approach may be performed in a fully automatic manner.

### EXEMPLARY EMBODIMENTS

In the following, further exemplary embodiments of the measuring device and the method for analyzing a sample will be explained.

According to an exemplary embodiment, the sample parameter refers to a volume of the sample and/or a density of the sample (see a detailed example further below). The sample parameter may also refer to other properties of the sample. Thereby, the sample parameter may be determined directly (and automatically) using the control unit or calculated based on other parameters measured directly by the measuring device.

According to another exemplary embodiment, the at least one resonance frequency of the received sonic standing waves comprises a first-harmonic resonance frequency (principal frequency). As the signals from the first resonance frequencies are stronger in comparison to the signals from higher (second/third) resonance frequencies, the measurement may be conducted easier and in a highly accurate manner.

According to another exemplary embodiment, the at least one resonance frequency of the received sonic standing waves comprises one of a second-harmonic resonance frequency, a third-harmonic resonance frequency, a higher harmonic resonance frequency. Using resonance frequencies comprising higher harmonics (e.g. second, third, fourth or higher harmonics) to determine sample parameters allows a significant reduction of measuring errors. In particular, certain materials may have a better-defined surface profile at higher harmonics, thereby ensuring clear signals and reliable measuring results.

The second harmonic is twice the principal frequency, e.g. if the principal frequency is 200 Hz, the second harmonic frequency would be 400 Hz.

In the context of the present document, the term “the received standing sonic waves comprise a second-harmonic resonance frequency and/or a third-harmonics resonance frequency” may mean that the second, third etc. harmonics are used for determination of the fluid column height instead of the first-harmonic resonance frequency (principal frequency). Potentially, higher harmonics than the second or third can be used for determination of the fluid column height.

According to another exemplary embodiment, the uniform cross-section of the container is at least one of circular, oval, square, rectangular, polygonal.

In an example, the shape of the container may be at least one of cylindrical, triangular, quadrangular. Basically, the container may comprise any shape, which may foster the reflection of the sonic waves. Dimensions of the container are to be chosen so that the resonance frequencies of the container vibrations do not match the resonance frequency determined based on the received sonic standing waves. In an example, the container may comprise a standardized volume, such as 250 mL, 100 mL, or 25 mL.

The container may further comprise materials with a high acoustic impedance such as metal, glass, concrete etc. (hard materials) or soft materials (e.g. a liquid surface).

According to another exemplary embodiment, the measuring device further comprises a cover structure, in particular a (tight-fitting, in particular gas-tight-fitting) plug, and the sonic emitter unit and/or the sonic receiver unit, and/or at least a part of the control unit, in particular an audio interface of the control unit, is/are arranged at the cover structure. Thereby, the cover structure may be one of a plug, a lid, a screw-top, or another cover. In another example, the cover structure may be removed from the container by lifting or turning it.

In an embodiment, the sonic emitter unit and/or the sonic receiver unit and/or at least a part of the control unit may be arranged on the surface of the cover structure or integrated within the cover structure. In this regard, the sonic emitter unit and/or the sonic receiver unit and/or at least a part of the control unit may be protected from mechanical damage. Further, both units may be transportable in an easy and straightforward manner.

In order to provide redundancy and/or to rule out resonance caused by transverse modes, there may be a plurality of the sonic emitter units and/or sonic receiver units integrated into the single cover structure. Thereby, the measurement errors caused by the transverse modes can be suppressed.

Thereby, the cover structure may comprise a plurality of parts which are connected with each other, e.g. a top part and a bottom part or an integrated part and a cover part. This may be advantageous as these parts may be exchangeable. These parts of the cover structure may also comprise sensors configured for other measurements.

In an exemplary embodiment, the sonic emitter unit and/or sonic receiver unit and/or audio interface of the control unit are flush with the bottom part/surface of the cover structure facing into the cylinder and towards the sample. In this arrangement, the sonic emitter unit and the sonic receiver unit are located at the pressure nodes under longitudinal modes.

Acoustic nodes can be present along the longitudinal (cylinder) axis or transversal axis. This means the amplitude of sound can change depending on the location. However, its resonance frequency does not change because it is determined by the fluid column length. Thus, the sonic emitter unit and the sonic receiver unit may be located at random locations along both axes.

Moreover, such a cover structure may be used for a plurality of containers to conduct a series of measurements, which may be advantageous in terms of measuring simplicity and speed. For example, there may be provided a robotic arm to move the cover structure from one container to another. In another example, the cover structure may be stationary, and the containers may be moved.

According to another exemplary embodiment, the measuring device is configured so that, when the cover structure is arranged at the container, in particular on (or over) the container, the sonic emitter unit and/or the sonic receiver unit is in contact, in particular in physical contact, with a fluid present in the container volume. This is advantageous in terms of signal transmission efficiency.

According to another exemplary embodiment, the container is fluid, tight, in particular gas-tight, and/or hermetically sealed when the cover structure is arranged at the container, in particular on the container. This may help to reduce external noise, which may interfere with the sonic signals sent by the sonic emitter and meant to be picked up by the sonic receiver, and therefore allow for a more precise measurement. Moreover, such a sealed container may provide a stable environment in the container volume, in particular regarding temperature and uniform cross section of the container, thus fostering efficient sound propagation inside the container. Additionally, the hermetically sealed container may allow for the container volume to be (essentially) free of foreign matter, e.g. dust.

According to another exemplary embodiment, a bottom part/surface of the cover structure, which is inside of the container, when the cover structure is arranged at the container, is planar. This allows a more accurate measurement of the height of the fluid column.

According to another exemplary embodiment, the sonic emitter unit is configured as a transducer, in particular a loudspeaker. The advantage may be that the loudspeakers can cover a wide range of frequencies. Further, a loudspeaker is a well-established, low-cost means that can be directly implemented.

Alternatively, the transducer can be used as a sonic emitter unit (loudspeaker) or as a sonic receiver unit (microphone), which can convert electrical signals into sound and vice versa.

According to another exemplary embodiment, the sonic receiver unit is configured as a microphone. The advantage may be in a sensitivity of such a sonic receiver unit as the microphone can capture a wide range of sound levels. Further, as the microphone can capture a wide spectrum of frequencies, such a sonic receiver unit may be advantageous in terms of the frequency response.

The sonic receiver may be also configured as different types of sensors depending on e.g. the frequency range or the sensitivity.

According to another exemplary embodiment, at least a part of the control unit is detachably or permanently coupled, in particular connected, to the container. In an example, the control unit, in particular an audio interface of the control unit (associated with the actual control unit), is housed within the housing of the measuring instrument and is coupled, in particular connected, to the cover structure comprising the sonic receiver unit and the sonic emitter unit. In this regard, the control unit and the cover structure comprising the sonic emitter unit the sonic receiver unit may be physically connected by means of a cable or may be connected in a wireless manner.

According to another exemplary embodiment a first control element (of the control unit) is housed in the housing of the measuring device whereas a second control element (of the control unit), the audio interface (of or associated with the control unit), the sonic emitter unit and sonic receiver unit are integrated in a different housing, in particular the cover structure, which may be advantageous in that it provides a space-saving setup.

Further, the first control element and the cover structure comprising the second control element, the audio interface, the sonic emitter and the sonic receiver may be wirelessly connected. This offers the advantage of mobility. Thus, measurements may be taken and monitored from different locations within the range of a wireless network.

According to another exemplary disclosure, the control unit is housed within the housing of the measuring instrument and is coupled, in particular connected, to the cover structure containing the sonic receiver, the sonic emitter and the audio interface. In this regard, the control unit and the cover structure containing the sonic emitter unit and the sonic receiver unit may be physically connected by means of a cable or may be connected in a wireless manner.

According to another exemplary embodiment, the sample is in a solid state. Thereby, the sample may comprise one of a single crystal, polycrystalline material or granular solid, an amorphous solid, a powder or a particulate solid or a composite. In particular, the sample may be one of a metallic powder, a pharmaceutical powder, a metal powder,, a pigment, a formed catalyst, a fine catalyst, or a coffee powder. The uniform distribution of the sample within the container may ensure accurate measurement results.

According to another exemplary embodiment, the sample comprises particles. Thereby, the sample particles may vary in size, shape, surface structure and surface area, density, porosity and other characteristics, which may impact the sonic wave propagation and thereby the measuring accuracy.

The sample may also comprise a homogenous or a heterogeneous distribution of particle sizes. Accordingly, the particles may comprise different acoustic properties.

According to another exemplary embodiment, the sample is in a liquid state.

According to another exemplary embodiment, the control unit is configured to calculate a height of a fluid column present in the container volume and being in contact with the sample (in particular between sample and cover structure and/or edge of container sidewall) based on the at least one determined resonance frequency.

The height/length (h) of a fluid column in the container may be determined according to the following equation:

$$h = \frac{ϑ}{2 f}$$

wherein 9 is the sound velocity in the fluid and f is a resonance frequency of the acoustic signal. The sound velocity 9 in the air may be calculated/determined according to established methods. Thus, based on the known sound velocity and the resonance frequency to be measured, the height of the fluid column (gas or liquid, e.g. air or water) can be calculated. In this example, f is f1, i.e. the principal frequency. The second harmonics (f2) will be double the value of the principal frequency, and the third (f3) will be triple the value of the principal frequency.

In the following table, exemplary values are given for a specific example:

| Height (mL) | 0 | 20 | 40 | 60 | 80 | 100 |
|---|---|---|---|---|---|---|
| f1 (Hz) | 736.2 | 871.7 | 1078.4 | 1415.7 | 2060.3 | 3766.0 |

According to another exemplary embodiment, the control unit is configured to calculate a volume of the sample based on the height of the fluid column.

The volume of the sample may be calculated using the following equation:

$${V}_{sample} = {V}_{container} - {V}_{fluid}$$

wherein V_{container} is a volume of an empty container and V_{fluid} is a volume of a fluid inside of the container, i.e. the fluid column that has been determined above. Based on the determined height of the fluid volume, the volume can be determined:

$${V}_{fluid} = h \cdot A$$

wherein A is the cross-section area of the container and h is the height of the fluid column in the container.

Thereby, the volume of the sample may be calculated before and after the tapping or compacting the sample inside of the container volume. This can be done in an efficient and automatic manner.

According to another exemplary embodiment, the control unit (in particular a first control element and/or a second control element) is configured to calculate a density of the sample based on the volume of the sample present in the container volume.

The density ρ may be calculated e.g. using the following equation:

$$ρ = \frac{m}{{V}_{sample}}$$

wherein m is the mass (in particular known/measured before) of the sample inside the container and Vₛₐₘₚₗₑ is the volume of the sample inside of the container. The mass of the sample may be determined by means of e.g. a balance prior to the sample being filled into the container for the sample volume measurement.

According to another exemplary embodiment, the method comprises calculating a height of a fluid column present in the container volume in contact with the sample based on at least one determined resonance frequency.

An acoustic spectrum may be created using acoustic signals that vary in frequency (sinusoidal sweep). The acoustic signals are sent towards the sample using the sonic emitter unit. The sonic waves propagate within the fluidic column above the sample, and reflect back from the surface of the sample placed within the container volume and the resulting standing waves are subsequently recorded using the sonic receiver unit. Then a resonance frequency (or multiple resonance frequencies) can be determined based on the acoustic spectrum of the received standing waves and at least one sample parameter can be determined based on the at least one determined resonance frequency.

According to another exemplary embodiment, the method further comprises calculating a volume of the sample based on the height of the fluid column. The sample volume may be calculated automatically using the above-mentioned formula by means of the control unit.

According to another exemplary embodiment, the method further comprises calculating a density of the sample based on the volume of the sample present in the container volume.

According to another exemplary embodiment, the measuring device may be provided with a housing, configured to receive the sample container, to provide means of displaying results to the operator and input means (e.g. a touchscreen) for the operator to input data, in particular data relating to the sample and/or the measurement to be performed, to house a control unit or (in an exemplary embodiment) a first control element and to provide coupling means for coupling the cover structure and/or the sonic emitter unit and/or sonic receiver unit and/or (in an alternative exemplary embodiment) a second control element.

According to another exemplary embodiment, the control unit may comprise a part (first control element) configured to receive information from another part of the control unit (second control element) and determine a sample parameter based on the at least one determined resonance frequency.

### BRIEF DESCRIPTION OF THE DRAWINGS

FIG. 1 illustrates a container with a sample and a cover structure provided with a sonic emitter unit, a sonic receiver unit and a control unit, according to an exemplary embodiment of the disclosure.

FIG. 2 illustrates a cover structure provided with a sonic emitter unit and a sonic receiver unit, according to a further exemplary embodiment of the disclosure.

FIGS. 3A-C illustrate exemplary embodiments of a measuring device provided with a container, a sonic emitter unit, a sonic receiver unit, and a control unit, according to further exemplary embodiments of the disclosure.

FIG. 4 illustrates an acoustic spectrum, according to a further exemplary embodiment of the disclosure.

### DETAILED DESCRIPTION OF THE DRAWINGS

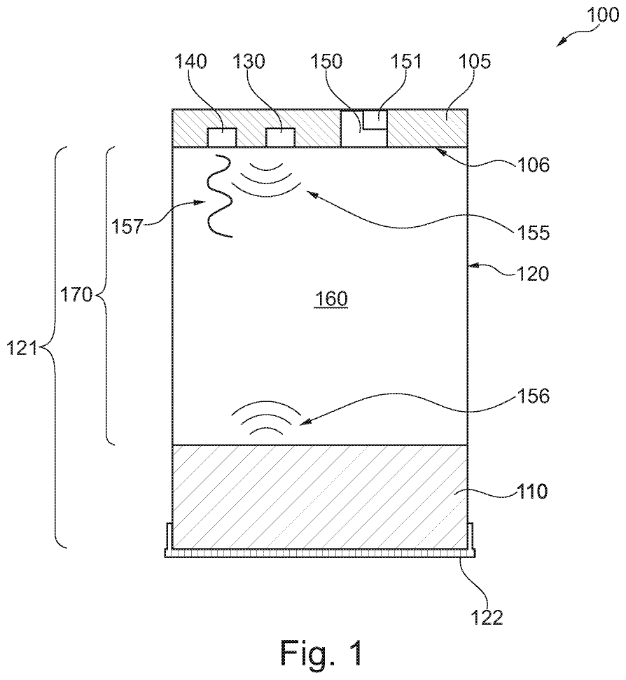

FIG. 1 illustrates a measuring device 100 with a cylindrical container 120, according to an exemplary embodiment of the disclosure, having a uniform circular cross-section and comprising a container volume 121. The container 120 accommodates a sample 110 and a fluid 160 inside of the container volume 121. The container volume 121 in this specific example is 100 mL and the sample 110 comprises a powder.

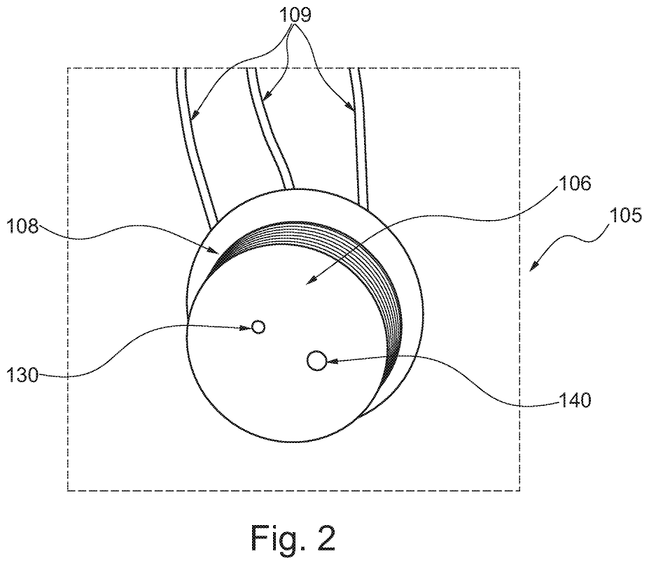

A cover structure 105, configured in this example as a plug, is arranged on the container 120. The plug 105 can also be arranged at least partially in the container 120 (between the upper sidewall portions of the container 120), thereby sealing the container 120 in a fluid-tight manner. The cover structure 105 is provided with a sonic emitter unit 130 and a sonic receiver unit 140 (see FIG. 2 for details) arranged on a planar surface of the bottom part 106 of the cover structure 105, so that the sonic emitter unit 130 and the sonic receiver unit 140 are in physical contact with the fluid 160 present in the container volume 121.

The sonic emitter unit 130 is configured as a loudspeaker, whereas the sonic receiver unit 140 is configured as a microphone in this example. Sonic waves 155 sent by the sonic emitter unit 130 are illustrated as a series of curved parallel lines convex in the direction of the sample 110. Reflected sonic waves 156 are illustrated as a series of curved parallel lines convex from the sample 110 in the direction towards the sonic receiver unit 140. In other words, the sonic waves cross the fluid column 170 down to the sample 110 and back to the cover structure 105. Hereby, standing acoustic waves 157 can be generated. Said standing waves 157 are detected by the sonic receiver 140.

Further, in this example, a control unit 150 (with an audio interface 151) for processing the received standing waves 157 is integrated in the cover structure 105.

FIG. 2 illustrates a cover structure 105 as described above in detail, according to an exemplary embodiment of the disclosure. The cover structure 105 is provided with two parts, which are connected: a top part 108 and a bottom part 106 arranged in this example as a plastic disc. The bottom part 106 comprises a planar surface with a smaller width than the top part 108. In this configuration, the cover structure 105 can be used as a plug: the bottom part 106 will be introduced into the container 120, while the top part 108 will be used as a stopper and cover the container 120 (in a fluid-tight manner). Two openings are arranged in the surface of the bottom part 106, in which a loudspeaker (sonic emitter unit) 130 and a microphone (sonic receiver unit) 140 are integrated, thereby providing a direct connection channel to the embedded loudspeaker 130 and microphone 140. The loudspeaker 130 and the microphone 140 are in direct physical contact with the fluid column 170 (not shown in FIG. 2), when the cover structure 105 is arranged at or on the container 120.

The cover structure 105 further comprises electric connections (cables) 109 to connect the cover structure 105 with a control unit 150 (not shown in FIG. 2), which is configured to control the loudspeaker 130 and record the audio waveforms from the microphone 140.

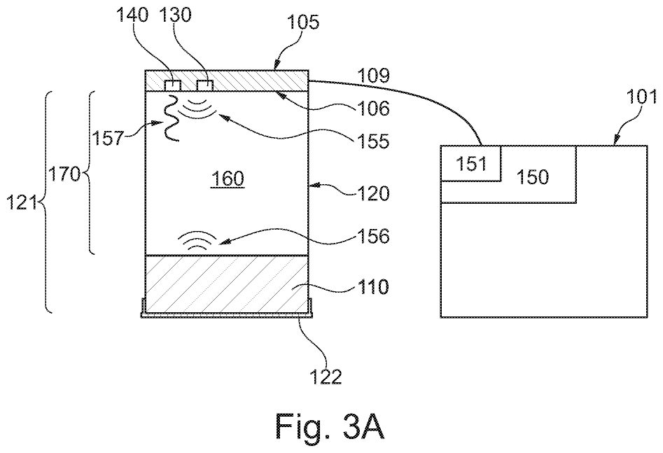

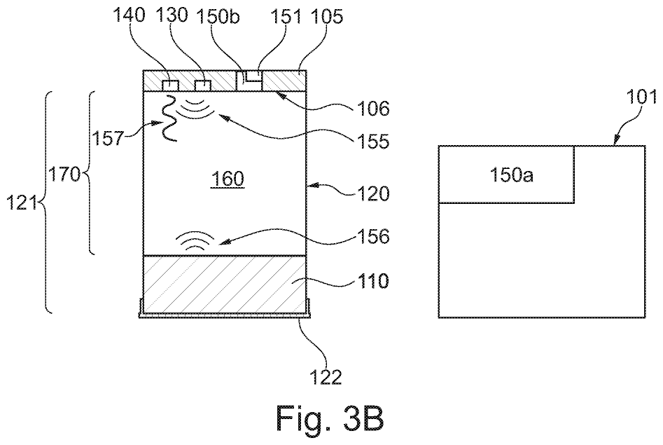

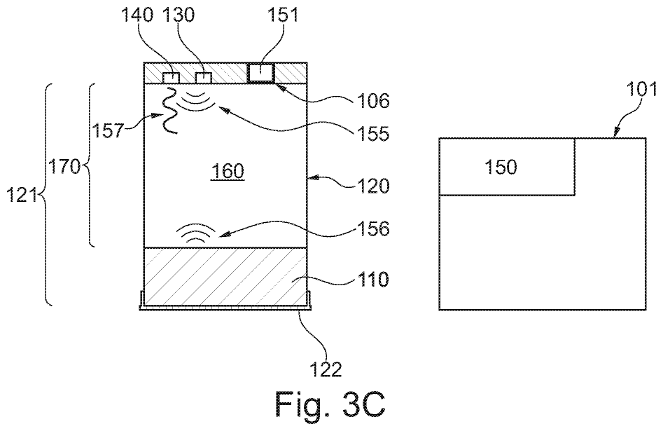

FIG. 3A illustrates a measuring device 100 comprising a graduated container 120, a cover unit 105 housing a sonic emitter unit 130, and a sonic receiver unit 140 according to an exemplary embodiment of the disclosure. The container 120 is filled partially with a sample 110 (here: powder). The container 120 is partly arranged in a base structure 122 configured to keep the container 120 in a vertical position. The container 120 further comprises a cover structure 105 partly inserted into the container 120. In this example, the cover structure 105, comprising the sonic emitter unit 130 and the sonic receiver unit 140 integrated therein, is connected to an audio interface 151 of a control unit 150 within a housing 101 by means of the electric connection (cables) 109 (alternatively wireless).

The control unit 150 is housed in the housing 101 of the measuring device 100 and configured as a computer. The audio interface 151 acts as an external sound card, processing sound inputs (and outputs) and transforming it into digital data compatible with a computer software to process the data (and e.g. determine a density of the sample).

FIG. 3B illustrates an alternative embodiment of FIG. 3A, wherein the cover structure 105 additionally comprises integrated therein a second control element 150b (of the control unit 150) with the audio interface 151 (of the control unit 150). Said second control element 150b is (in this example wirelessly) coupled to a first control element 150a (of the control unit 150) within the housing 101.

FIG. 3C illustrates an alternative embodiment of FIG. 3B, wherein the cover structure 105, comprises only the audio interface 151 (associated with the control unit 150) integrated therein. The actual control unit 150 is integrated in the housing 101 and is coupled to said audio interface 151, e.g. in a wired or wireless manner.

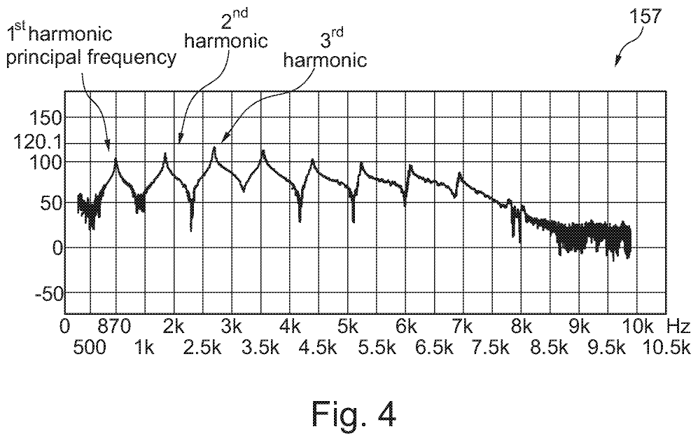

FIG. 4 illustrates a line graph describing an acoustic spectrum of a signal generated for the sample 110 in the container 120 (here a volume of 100 mL), according to an exemplary embodiment of the disclosure. The acoustic spectrum of the signal shows the sound pressure level (SPL) as a function of frequency (in Hz). Therein, the X-axis represents the signal frequency, and the Y-axis shows said Sound Pressure Level (SPL). In this example, an acoustic spectrum is created using a signal based on the received standing sonic waves 157 that varies in frequency (sinusoidal frequency sweep). The frequency sweep comprises a length of 256 K. The signal is emitted via speaker 130 into the container volume 121, where the acoustic spectrum is then measured. As the sonic waves 155 are sent, they interact with the sample 110 placed within the container volume 121 and standing sonic waves 157, resulting from a combination of emitted sonic waves 155 and the reflected sonic waves 156, are recorded using the microphone 140. Then, multiple resonance frequencies can be determined based on the received standing sonic waves 157 of the acoustic spectrum and the at least one sample parameter can be determined based on the determined resonance frequencies.

### Reference signs

100 measuring device
101 housing
105 cover structure
106 bottom part
108 top part
110 sample
120 container
121 container volume
122 base structure
130 sonic emitter unit
140 sonic receiver unit
150 control unit
150a first control element (of the control unit)
150b second control element (of the control unit)
151 audio interface (of the control unit)
155 emitted sonic wave
156 reflected sonic wave
157 standing sonic wave
160 fluid
170 fluid column

1. A measuring device for analyzing a sample, which comprises:
a container configured to accommodate the sample in a container volume, wherein the container comprises a uniform cross-section;
a sonic emitter unit configured to emit sonic waves into the container towards the sample;
a sonic receiver unit configured to receive reflected sonic waves, and standing sonic waves, which are formed by combinations of the emitted sonic waves and the reflected sonic waves; and
a control unit configured to determine at least one resonance frequency based on the received standing sonic waves and to determine at least one sample parameter based on the at least one determined resonance frequency.

2. The measuring device according to claim 1,
wherein the sample parameter refers to a volume of the sample and/or a density of the sample.

3. The measuring device according to claim 1,
wherein the at least one resonance frequency of the received standing sonic waves comprises a first-harmonic resonance frequency.

4. The measuring device according to claim 1,
wherein the at least one resonance frequency of the standing sonic waves comprises at least one of a second harmonic frequency, a third harmonic frequency, a higher harmonic frequency.

5. The measuring device according to claim 1, comprising at least one of the following features:
wherein the uniform cross-section of the container is at least one of circular, oval, square, rectangular, polygonal;
wherein the shape of the container is at least one of cylindrical, triangular, quadrangular.

6. The measuring device according to claim 1, further comprising:
a cover structure, in particular a plug,
wherein at least one of the sonic emitter unit, the sonic receiver unit, the control unit, in particular an audio interface of the control unit, is arranged at or integrated within the cover structure.

7. The measuring device according to claim 6,
wherein the measuring device is configured so that, when the cover structure is arranged at the container, in particular on the container, the sonic emitter unit and/or the sonic receiver unit is/are in contact, in particular in physical contact, with a fluid present in the container volume.

8. The measuring device according to claim 6,
wherein the container is fluid-tight sealed when the cover structure is arranged at the container, in particular on the container.

9. The measuring device according to claim 6,
wherein the surface of the bottom part of the cover structure, which is inside of the container, when the cover structure is arranged at the container, is planar.

10. The measuring device according to claim 1,
wherein the sonic emitter unit is configured as a transducer, in particular a loudspeaker.

11. The measuring device according to claim 1,
wherein the sonic receiver unit is configured as a microphone.

12. The measuring device according to claim 1,
wherein at least a part, in particular a second control element, of the control unit is detachably or permanently coupled, in particular connected, to the container.

13. The measuring device according to claim 1,
wherein the sample is in a solid state.

14. The measuring device according to claim 1,
wherein the sample comprises particles, in particular a powder.

15. The measuring device according to claim 1,
wherein the sample is in a liquid state.

16. The measuring device according to claim 1,
wherein the control unit is configured to calculate a height and/or length of a fluid column present in the container volume in contact with the sample based on the at least one determined resonance frequency.

17. The measuring device according to claim 16,
wherein the control unit is configured to calculate a volume of the sample based on the height and/or length of the fluid column.

18. The measuring device according to claim 17,
wherein the control unit is configured to calculate a density of the sample based on the volume of the sample present in the container volume.

19. A method of analyzing a sample, wherein the method comprises:
providing a sample in a container;
emitting sonic waves into the container towards the sample;
receiving standing sonic waves, which are formed by combinations of the emitted sonic waves and reflected sonic waves;
determining at least one resonance frequency based on the received standing sonic waves; and
determining a sample parameter based on the at least one determined resonance frequency.

20. The method according to claim 19, wherein the method further comprises at least one of the following features:
calculating a height of a fluid column present in the container volume in contact with the sample based on the at least one determined resonance frequency;
calculating a volume of the sample based on the height of the fluid column;
calculating a density of the sample based on the volume of the sample present in the container volume.
